(19) United States
(12) Patent Application Publication
(10) Pub. No.: US 2008/0106555 A1
(43) Pub. Date: May 8, 2008

(54) Method and apparatus for driving display panel

(76) Inventor: Young-Jun Jeon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/985,084

(22) Filed: Nov. 14, 2007

(30) Foreign Application Priority Data
Nov. 2, 2006 (KR) 2006-0116033

(51) Int. Cl. G09G 5/10

(52) U.S. Cl. 345/691; 345/204; 345/67

(57) ABSTRACT

An apparatus configured to drive a display panel by applying voltages of one or more levels to each of a plurality of electrode lines is disclosed. The apparatus includes first control switches configured to control a connection between a power source of a first level and each of the electrode lines and second control switches configured to control a connection between a power source of a second level and each of the electrode lines, wherein, when the power supply voltage of the first level or the second level is applied to the electrode lines, the electrode lines are divided into two or more groups, and the first control switches and the second control switches have different switching times according to the group to which they belong.

### CROSS-REFERENCE TO RELATED PATENT APPLICATIONS

This application claims the benefit of Korean Patent Application No. 10-2006-0116033, filed on Nov. 22, 2006, in the Korean Intellectual Property Office, the disclosure of which is incorporated herein in its entirety by reference.

### BACKGROUND OF THE INVENTION

1. Field of the Invention

The field relates to a method and apparatus for driving a display panel, and more particularly, to a method and apparatus for driving a display panel that displays an image by generating a repetitive discharge over a short time period using an electrical signal having a high voltage and high frequency.

2. Description of the Related Technology

Plasma display panels (PDPs) have become widely popular because they can be easily manufactured as large-sized flat panel displays. A PDP represents images using a discharge phenomenon. Generally, plasma display panels can be classified into DC type plasma display panels and AC type plasma display panels according to the driving voltage. Since DC type plasma display panels have a long discharge delay time, current focus is on the development of AC type PDPs.

A representative AC-type PDP is a 3-electrode AC surface discharge PDP which includes three electrode groups and is driven by AC voltages. Since a 3-electrode surface discharge PDP, which is composed of a plurality of layers, is thinner and lighter than a conventional cathode-ray tube (CRT), it can be used to create a large-sized screen.

A conventional 3-electrode surface discharge type PDP and a driving apparatus and method thereof are disclosed in U.S. Pat. No. 6,744,218 entitled “Method of Driving a Plasma Display Panel in which the Width of Display Sustain Pulse Varies”. The PDP and the driving apparatus and method thereof, which are disclosed in U.S. Pat. No. 6,744,218, are incorporated herein by reference and a detailed description thereof is omitted.

The PDP includes a plurality of display cells in which sustain electrodes and address electrodes cross each other, wherein each display cell consists of three (red, green, and blue) discharge cells and a gray scale of an image is represented by adjusting discharge states of the discharge cells.

In order to represent the gray scale of the PDP, a frame is used, which is a display cycle divided into a plurality of subfields. Each frame applied to the plasma display panel may be divided into, for example, 8 subfields having different light-emitting frequencies, thereby representing 256 gray scales. In order to display an image using 256 gray scales, a frame period (16.67 ms) corresponding to 1/60 second is divided into 8 subfields. Each subfield is divided into a reset period, an address period, and a sustain-discharge period.

A unit light of the PDP increases so that a discharge sustain voltage necessary for the discharge increases, and a frequency increases in order to increase the brightness of the plasma display panel. A high voltage having a high frequency is applied to each of a plurality of electrode lines in order to drive the plasma display panel. To this end, a switching device performs switching as necessary.

Two switching devices control a power supply that is to be applied to each electrode line in order to apply a signal having two levels to a panel capacitor. According to a method of driving the PDP, the same signal can be applied to all Y electrode lines during a specific period. The switching devices connected to all of the Y electrode lines during the specific period can be simultaneously powered either on or off.

Accordingly, a current flow in all the Y electrode lines can abruptly change, which causes a great amount of electromagnetic interference (EMI).

### SUMMARY OF CERTAIN INVENTIVE ASPECTS

One aspect is an apparatus configured to drive a display panel by applying voltages of one or more levels to each of a plurality of electrode lines, where the plurality of electrode lines are divided into a plurality of groups of electrode lines. The apparatus includes at least two first control switches, each of the first control switches configured to control a connection between a power source of a first level and one of the groups of electrode lines, where the first control switches are configured to switch the power source of the first level to each of the electrode lines at a time determined based at least in part on the group the electrode lines are associated with, and at least two second control switches, and each of the second control switches are configured to control a connection between a power source of a second level and one of the groups of electrode lines, where the second control switches are configured to switch the power source of the second level to each of the electrode lines at a time determined based at least in part on the group the electrode lines are associated with.

Another aspect is an apparatus configured to drive a display panel including discharge cells formed near where X electrode lines and Y electrode lines extend so as to cross address electrode lines, where the Y electrode lines are divided into a plurality of groups of Y electrode lines. The apparatus includes at least two first control switches, each of the first control switches configured to control a connection between a power source of a first level and one of the groups of Y electrode lines, where the first control switches are configured to switch the power source of the first level to each of the Y electrode lines at a time determined based at least in part on the group the Y electrode lines are associated with, and at least two second control switches, and each of the second control switches configured to control a connection between a power source of a second level and one of the groups of Y electrode lines, where the second control switches are configured to switch the power source of the first level to each of the Y electrode lines at a time determined based at least in part on the group the Y electrode lines are associated with, where the apparatus is configured to apply voltages of one or more levels to each of the Y electrode lines.

Another aspect is a method of driving a display panel, the method including applying voltages of one or more levels to each of a plurality of electrode lines with an apparatus configured to drive the display panel, where the electrode lines are divided into a plurality of groups of electrode lines. The apparatus includes at least two first control switches, each of the first control switches configured to control a connection between a power source of a first level and one of the groups of electrode lines, where the first control switches are configured to switch the power source of the first level to each of the electrode lines at a time determined based at least in part on the group the electrode lines are associated with, and at least two second control switches, each of the second control switches configured to control a connection between a power source of a second level and one of the groups of electrode lines, where the second control switches are configured to switch the power source of the second level to each of the electrode lines at a time determined based at least in part on the group the electrode lines are associated with.

### BRIEF DESCRIPTION OF THE DRAWINGS

The above and other features and advantages of the present invention will become more apparent by describing certain embodiments thereof with reference to the attached drawings in which:

FIG. 1 is a perspective view of a 3-electrode surface discharge plasma display panel (PDP) to which a plasma display panel driving apparatus according to one embodiment is applied;

FIG. 2 is a block diagram of an apparatus for driving the PDP illustrated in FIG. 1 according to one embodiment;

FIG. 3 is a circuit diagram schematically illustrating a Y driver of the apparatus for driving the PDP illustrated in FIG. 2 according to one embodiment;

FIG. 4 is a timing diagram of a PDP driving method in which a unit frame is divided into a plurality of subfields, according to one embodiment;

FIG. 5 is a schematic diagram illustrating Y electrode lines of the PDP illustrated in FIG. 1, which are sequentially divided into two groups;

FIG. 6 is a timing diagram illustrating driving signals from drivers illustrated in FIG. 2 for the Y electrode lines illustrated in FIG. 5 according to an embodiment;

FIG. 7 is a schematic diagram illustrating the Y electrode lines of the PDP illustrated in FIG. 1, in which even electrode lines and odd electrode lines are divided into two groups; and

FIG. 8 is a timing diagram illustrating driving signals from drivers illustrated in FIG. 2 for the Y electrode lines illustrated in FIG. 7 according to another embodiment of the present invention.

### DETAILED DESCRIPTION OF CERTAIN INVENTIVE EMBODIMENTS

Certain embodiments will now be described more fully with reference to the accompanying drawings, in which embodiments are shown.

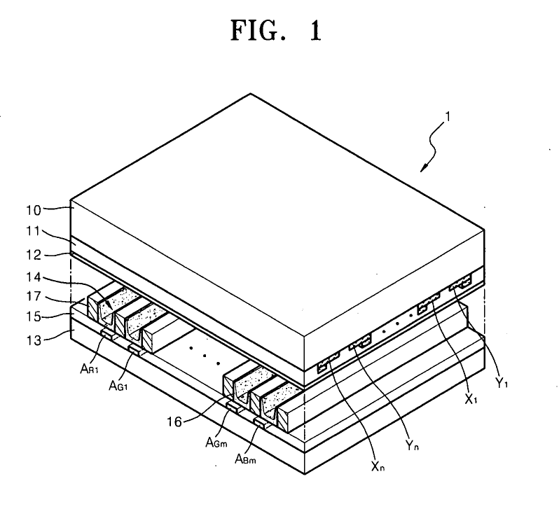

FIG. 1 is a perspective view of a 3-electrode surface discharge plasma display panel (PDP) 1 to which a plasma display panel driving apparatus according to an embodiment is applied.

Referring to FIG. 1, address electrode lines A_{R1} through to A_{Bm}, upper and lower dielectric layers 11 and 15, Y electrode lines Y₁ through to Yₙ, X electrode lines X₁ through to Xₙ, phosphor layers 16, barrier ribs 17, and a MgO layer 12 which is a protection layer, are formed between front and rear glass substrates 10 and 13 of the surface discharge PDP 1.

The address electrode lines A_{R1} through to A_{Bm} are formed in a predetermined pattern on an upper surface of the rear glass substrate 13. The lower dielectric layer 15 buries the address electrode lines A_{R1} through to A_{Bm}. The barrier ribs 17 are formed parallel to the address electrode lines A_{R1} through to A_{Bm} on a surface of the lower dielectric layer 15. The barrier ribs 17 partition discharge areas and prevent cross talk between the discharge areas. The phosphor layers 16 are formed on sidewalls of the barrier ribs 17 and on the lower dielectric layer 15 formed on the rear glass substrate 13.

The X electrode lines X₁ through to Xₙ and the Y electrode lines Y₁ through to Yₙ are formed in a predetermined pattern on a lower surface of the front glass substrate 10 in such a manner that they cross over the address electrode lines A_{R1} through to A_{Bm}. Discharge cells 14 are defined near where the X electrode lines X₁ through to Xₙ and the Y electrode lines Y₁ through to Yₙ cross over the address electrode lines A_{R1} through to A_{Bm}. Each of the X electrode lines X₁ through to Xₙ and each of the Y electrode lines Y₁ through to Yₙ are formed by coupling a transparent conductive electrode formed of a material such as Indium Tin Oxide (ITO) with a metal electrode for increasing conductivity. Here, the X electrode lines X₁ through to Xₙ are common electrodes of the respective discharge cells 14, and the Y electrode lines Y₁ through to Yₙ are scan electrodes of the respective discharge cells 14.

Y electrode lines Y₁ through to Yₙ are scan electrodes to which scan pulses are sequentially applied in order to select the discharge cells 14 that are to be displayed.

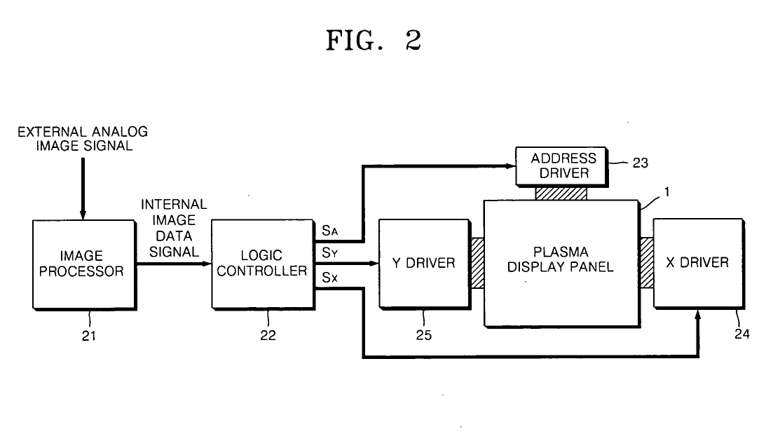

FIG. 2 is a block diagram of an apparatus 20 for driving the PDP 1 illustrated in FIG. 1 according to one embodiment.

Referring to FIG. 2, the PDP driving apparatus 20 includes an image processor 21, a logic controller 22, an address driver 23, an X driver 24, and a Y driver 25. The image processor 21 converts external analog image signals into digital signals and generates internal image data signals, such as red (R), green (G), and blue (B) image data signals, a clock signal, and vertical and horizontal synchronization signals. The logic controller 22 generates driving control signals S_{A}, S_{Y}, and S_{X} according to the internal image data signals received from the image processor 26. Here, the address driver 23, the X driver 24, and the Y driver 25 receive the driving control signals S_{A}, S_{Y}, and S_{X}, generate the corresponding driving signals, and applies the generated driving signals to the corresponding electrode lines.

That is, the address driver 23 applies a display data signal according to the address driving control signal S_{A} received from the logic controller 22 to the address electrode lines. The X driver 24 processes the X driving control signal S_{X} received from the logic controller 22, and applies a voltage corresponding to the X driving control signal S_{X} to the X electrode lines. The Y driver 25 processes the Y driving control signal S_{Y} received from the logic controller 22, and applies a voltage corresponding to the Y driving control signal S_{Y} to the Y electrode lines.

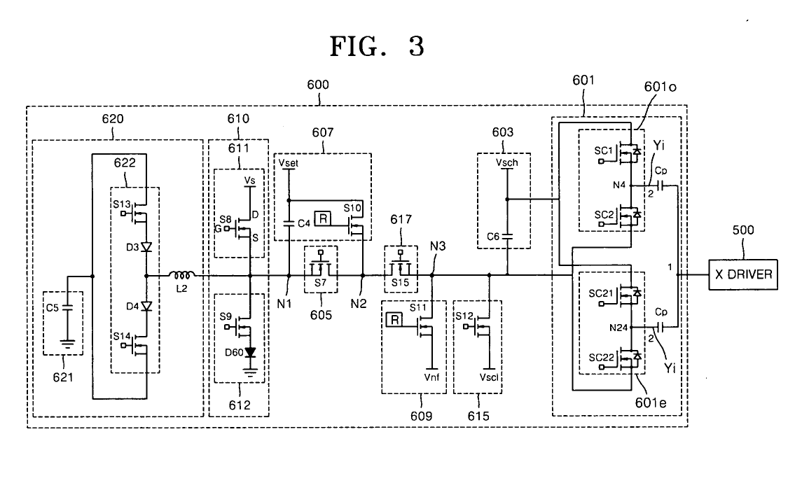

FIG. 3 is a circuit diagram schematically illustrating the Y driver 25 of the apparatus for driving the PDP illustrated in FIG. 2 according to an embodiment.

Referring to FIG. 3, the apparatus for driving the PDP comprises a sustain pulse applying unit 610, a first switching unit 605, a second switching unit 617, a third voltage applying unit 607, a fourth voltage applying unit 609, a scan switching unit 601, a fifth voltage applying unit 603, a sixth voltage applying unit 615, and an energy recovery unit 620.

The sustain pulse applying unit 610 comprises a first voltage applying unit 611 and a ground voltage applying unit 612. The first voltage applying unit 611 outputs a first voltage Vs to a first node N1 in order to output a driving signal to the Y electrodes (the second terminals of capacitors Cp). The ground voltage applying unit 612 outputs a ground voltage Vg to the first node N1.

The first switching unit 605 comprises a seventh switching device S7 having one terminal connected to the first node N1 and another terminal connected to a second node N2. The second switching unit 617 comprises a fifteenth switching device S15 having one terminal connected to the second node N2 and another terminal connected to a third node N3.

The third voltage applying unit 607, which is connected between the first node N1 and the second node N2, gradually increases the first voltage Vs to the level of a third voltage Vset at a predetermined rate, and outputs the first voltage Vs to the second node N2. The fourth voltage applying unit 609, which is connected between the third node N3, gradually lowers the first voltage Vs to the level of a fourth voltage Vnf at a predetermined rate, and outputs the first voltage Vs to the third node N3.

The scan switching unit 601 comprises a first block switching unit 601o and a second block switching unit 601e. The first block switching unit 601o and the second block switching unit 601e comprise first scan switching devices SC1 and SC21, and second scan switching devices SC2 and SC22, respectively. Fourth nodes N4 and N24 disposed between the first scan switching device SC1 and the second scan switching device SC2 and the first scan switching device SC21 and the second scan switching device SC22, respectively, are connected to the Y electrodes (the second terminals of capacitors Cp) of the plasma display panel.

The first bock switching unit 601o and the second block switching unit 601e may comprise a plurality of scan ICs capable of controlling the application of voltage from a power supply to the Y electrode lines. The scan switching unit 601 may comprise the plurality of scan ICs so that all the Y electrode lines are divided into a plurality of units, and the scan ICs may be respectively connected to the units.

The apparatus for driving the PDP that applies a plurality of voltages of one or more levels to each of a plurality of electrode lines in order to drive the PDP further comprises first control switches SC1 and SC21, and second control switches SC2 and SC22. In some embodiments, the first control switches SC1 and SC21, and the second control switches SC2 and SC22 can be respectively the first scan switching devices SC1 and SC21, and the second scan switching devices SC2 and SC22.

The first scan switching devices SC1 and SC21 control the connection between a power supply of a first level Vsch and each electrode line, which are the Y electrode lines Yi in the present embodiment. The second scan switching devices SC2 and SC22 control the connection between a power supply of a second level Vscl and each electrode line, which are the Y electrode lines Yi in the present embodiment.

When the voltage of the first level Vsch or the second level Vscl is applied to all the Y electrode lines Yi, all the Y electrode lines Yi are divided into two or more groups, and the first scan switching devices SC1 and SC21 and the second scan switching devices SC1 and SC21 have different switching times according to the groups. In detail, times when the first scan switching devices SC1 and SC22 are on and the second scan switching devices SC2 and SC22 are off are different from each other according to the groups. Similarly, times when the first scan switching devices SC1 and SC21 are off and the second scan switching devices SC2 and SC22 are on are different from each other according to the groups.

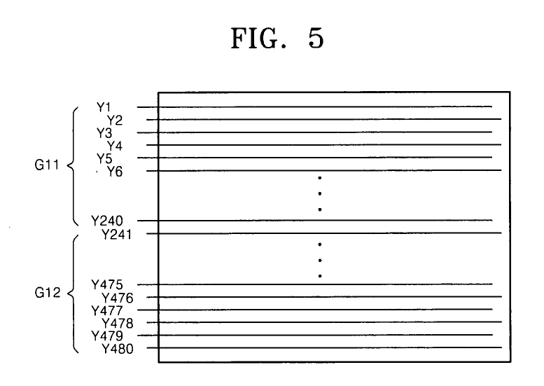

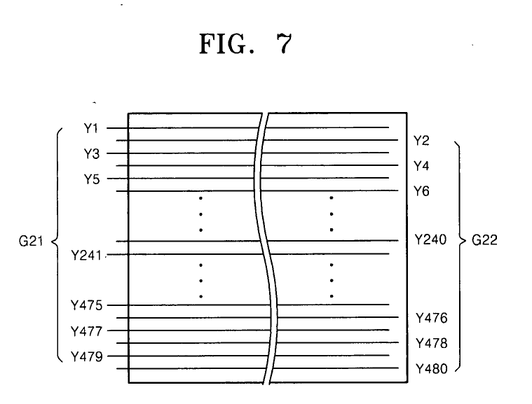

In the present embodiment, the Y electrode lines Yi can be divided into a first group (G11 in FIG. 5 and G21 in FIG. 7) and a second group (G12 in FIG. 5 and G22 in FIG. 7) as illustrated in FIGS. 5 or 7. The time when the first scan switching devices SC1 and SC22 are on and the second scan switching devices SC2 and SC22 are off, or the time when the first scan switching devices SC1 and SC22 are off and the second scan switching devices SC2 and SC22 are on in the second group (G11 in FIG. 5 and G21 in FIG. 7) comes after the time when the first scan switching devices SC1 and SC22 are on and the second scan switching devices SC2 and SC22 are off, or the time when the first scan switching devices SC1 and SC22 are off and the second scan switching devices SC2 and SC22 are on in the first group (G12 in FIG. 5 and G22 in FIG. 7).

The Y electrode lines Yi can be divided into two groups, and the first scan switching devices SC1 and SC21 and the second scan switching devices SC2 and SC22 have different switching times according to the groups so that current and voltage variances can be dispersed in time. Therefore, a peak value and an average value of a current in the Y electrode lines Yi through the scan ICs are smaller than conventionally, thereby reducing the amount of electromagnetic interference (EMI).

The fifth voltage applying unit 603, which comprises a fifth voltage source, is connected to the first scan switching devices SC1 and SC21, and outputs a fifth voltage Vsch of a first level to the first scan switching devices SC1 and SC21. The sixth voltage applying unit 615 and the fourth voltage applying unit 609 are connected to the third node N3 and the second scan switching devices SC2 and SC22 and output a sixth voltage Vscl of a second level.

The energy recovery unit 620 accumulates charges in the panel capacitor Cp or stores charges in the panel capacitor Cp.

The first voltage applying unit 611 comprises an eighth switching device S8 having one end connected to a first voltage source that supplies Vs and another end connected to the first node N1. The ground voltage applying unit 612 comprises a ninth switching device S9 having one end connected to ground and another end connected to the first node N1. The sustain pulse applying unit 610 alternatively turns on the eight switching device S8 and the ninth switching device S9 in order to generate a sustain pulse.

The eighth switching device S8 and the ninth switching device S9 may be field effect transistors (FETs) comprising a drain terminal, a gate terminal, and a source terminal. The drain terminal is connected to the first voltage source that supplies Vs. The gate terminal is connected to a driver (not shown). The source terminal is connected to the Y electrode lines Yi.

The third voltage applying unit 607 comprises a fourth capacitor C4 and a tenth switching device S10. One terminal of the fourth capacitor C4 is connected to the first node N1 and another terminal thereof is connected to a third voltage source that supplies Vset. The tenth switching device S1 is connected between the third voltage source that supplies Vset and the second node N3.

When the seventh switching device S7 of the first switching unit 605 is turned off, the fifteenth switching device S15 of the second switching unit 617 is turned on, the eighth switching device S8 of the first voltage applying unit 611 is turned on, the tenth switching device S10 of the third voltage applying unit 607 is turned on, and the first scan switching devices SC1 and SC21 of the scan switching unit 601 are turned on, so that a voltage gradually rises from the level of the fifth voltage Vsch to the level of the third voltage Vset at a predetermined rate and a rising maximum voltage Vset+Vsch is output to all of the Y electrode lines Yi via the fourth node N4.

The fourth voltage applying unit 609 comprises an eleventh switching device S11 having one terminal connected to the third node N3 and another terminal connected to a fourth voltage source that supplies Vnf. The eighth switching device S8 of the first voltage applying unit 611, the seventh switching device S7 of the first switching unit 605, the fifteenth switching device S15 of the second switching unit 617, and the eleventh switching device S11 of the fourth voltage applying unit 609 are turned on, so that a voltage gradually falls from the level of the first voltage Vs to the level of the fourth voltage Vnf and is output to the third node N3.

Accordingly, in the Y electrode lines Yi, the first scan switching devices SC1 and SC21 are turned off and the second scan switching devices SC2 and SC22 are turned on so that the scan switching unit 601 prevents the application of the fifth voltage Vsch. Therefore, the current of the scan switching unit 601 abruptly changes with regard to the Y electrode lines Yi, which results in EMI.

Therefore, the Y electrode lines Yi are divided into two or more groups, and the times when the first scan switching devices SC1 and SC21 are off and the second scan switching devices SC2 and SC22 are on are different according to the groups, thereby reducing the amount of EMI caused by the abrupt change in current.

The sixth voltage applying unit 615 comprises a twelfth switching device S12 connected between the third node N3 and the sixth voltage source that supplies Vscl. The twelfth switching device S12 is turned on and thus the sixth voltage Vscl is output to the third node N2.

If the first scan switching device SC1 of the scan switching unit 601 is turned on and the second scan switching device SC2 thereof is turned off, the fifth voltage Vsch is output to the Y electrodes (the second terminals of panel capacitors Cp) through the fourth node N4. To the contrary, if the first scan switching device SC1 of the scan switching unit 601 is turned off and the second scan switching device SC2 thereof is turned on, each voltage which is output to the third node N3, i.e., the first voltage Vs, the ground voltage Vg, the fourth voltage Vnf, and the sixth voltage Vscl, is output to the Y electrodes (the second terminals of panel capacitors Cp) through the fourth node N4.

The energy recovery unit 620 comprises an energy storage unit 621, an energy recovery switching unit 622, and an inductor L2. The energy storage unit 621 stores charges of the panel capacitors Cp. The energy recovery switching unit 622 is connected to the energy storage unit 621, and controls the charges stored in the energy storage unit 621 that are to be accumulated in the panel capacitors Cp or charges of the panel capacitors Cp that are to be stored in the energy storage unit 621. One terminal of the inductor L2 is connected to the energy recovery switching unit 622 and another terminal thereof is connected to the first node N1.

The energy storage unit 621 may comprise a capacitor C5 for storing the charges of the panel capacitors Cp. The energy recovery switching unit 622 comprises a thirteenth switching device S13 and a fourteenth switching device S14 each having one terminal connected to the energy storage unit 621 and another terminal connected to the inductor L2. Third and fourth diodes D3 and D4 may be connected between the thirteenth switching device S13 and the fourteenth switching device S14 in the opposite direction.

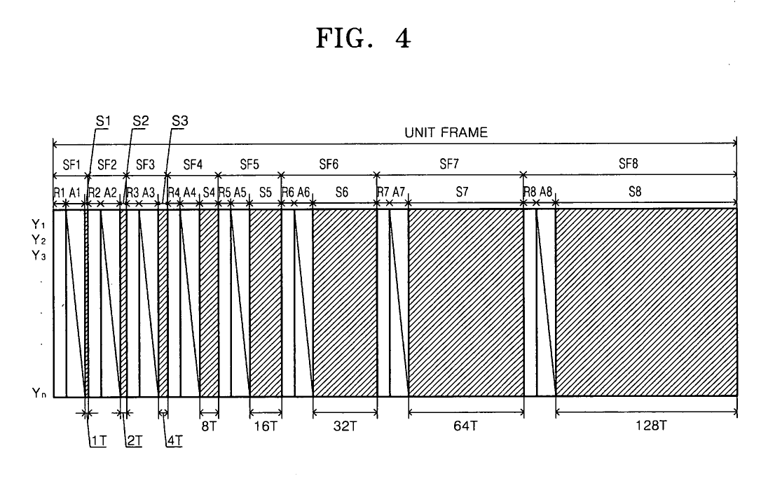

FIG. 4 is a timing diagram of a plasma display panel driving method in which a unit frame is divided into a plurality of subfields, according to an embodiment of the present invention.

Referring to FIG. 4, the unit frame FR is divided into 8 subfields SF1 through to SF8 for a time division gray scale display. Also, the respective subfields SF1 through to SF8 are respectively divided into reset periods R1 through to R8, address periods A1 through to A8, and sustain discharge periods S1 through to S8.

The brightness of the plasma display panel is proportional to the length of the sustain discharge periods S1 through to S8 in a unit frame. The total length of the sustain discharge periods S1 through to S8 in a unit frame is 255T (T is a unit of time). A time corresponding to 2ⁿ is set as the sustain discharge period Sn of an n-th subfield SFn. Accordingly, by appropriately selecting subfields to be displayed from among the 8 subfields, 256 gray scales including a zero gray scale which is not displayed in any subfield can be displayed.

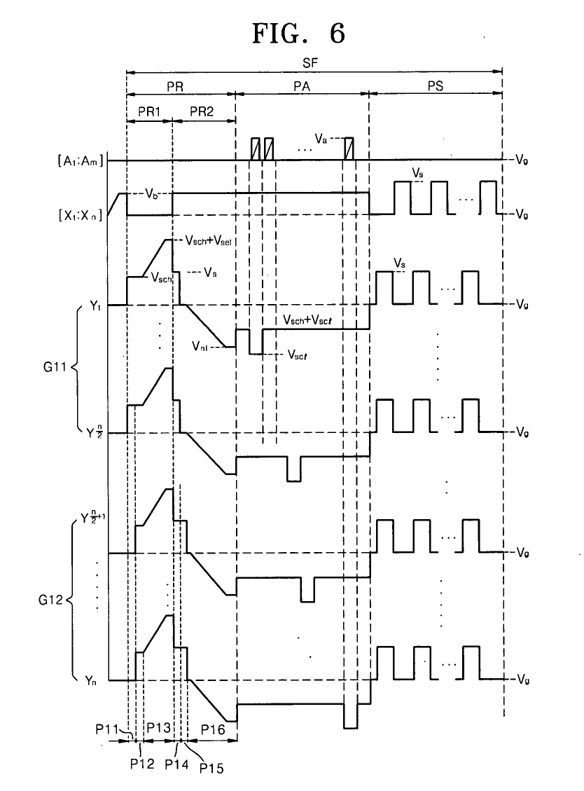

FIG. 5 is a diagram schematically illustrating the Y electrode lines Yi of the PDP 1 illustrated in FIG. 1, which are divided into two groups. FIG. 6 is a timing diagram of driving signals output from the drivers illustrated in FIG. 2 for the Y electrode lines illustrated in FIG. 5.

Referring to FIGS. 5 and 6, a method of driving the PDP applies voltages of one or more levels to each of a plurality of electrode lines using the apparatus for driving the PDP comprising the first control switches SC1 and SC21 and the second control switches SC2 and SC22 illustrated in FIG. 3. The first scan switching devices SC1 and SC21 control the connection between a power source of a first level Vsch and each electrode line, i.e., the Y electrode lines Yi in the present embodiment. The second scan switching devices SC2 and SC22 control the connection between each electrode line, i.e., the Y electrode lines Yi in the present embodiment, and a power source of a second level Vscl lower than the first level.

When the driver supplies the first level Vsch or the second level Vscl to all the Y electrode lines Yi, the Y electrode lines Yi are divided into two groups, and the first scan switching devices SC1 and SC21 and the second scan switching devices SC2 and SC22 have different switching times according to the groups. More specifically, times when the first scan switching devices SC1 and SC21 are on and the second scan switching devices SC2 and SC22 are off are different according to the groups, or times when the first scan switching devices SC1 and SC21 are off and the second scan switching devices SC2 and SC22 are on are different according to the groups.

A unit frame of the plasma display panel is divided into a plurality of subfields, wherein each subfield has a gray scale weight for driving time division gray scale display, and each subfield SF includes a reset period PR, an address period PA, and a sustain-discharge period PS.

The reset period PR includes a first reset period PR1 and a second reset period PR2, in which discharge cells are initialized.

In the first reset period PR1, a rising ramp pulse waveform voltage that continuously rises from the first level of Vsch to the third level of Vsch+Vset is applied to the Y electrode lines Yi. The X electrode lines and the address electrode lines are biased to the ground level of Vg.

In the second reset period PR2, a falling ramp waveform voltage that continuously falls from the fourth level of Vs to the fifth level of Vnf is applied to the Y electrode lines Yi. The X electrode lines are biased to a bias voltage Vb and a reset discharge is performed. The reset discharge initializes discharge cells.

The first reset period PR1 includes a first period P11, a second period P12, and a third period P13. In the first period P11, when the first control switch corresponding to a second group G12, i.e., the first scan switching device SC21, is off, and the second control switch corresponding to the second group G12, i.e., the second scan switching device SC22, is on, the first scan switching device SC1 corresponding to a first group G11 is on and the second switching device SC2 corresponding to the first group G11 is off.

In the second period P12, when the first scan switching device SC1 corresponding to the first group G11 is on and the second switching device SC2 corresponding to the first group G11 is off, the first scan switching device SC21 corresponding to the second group G12 is on, and the second scan switching device SC22 corresponding to the second group G12 is off. In the third period P13, a rising ramp pulse waveform voltage that continuously rises from the first level of Vsch to the third level of Vsch+Vset is applied to the Y electrode lines Yi.

The second reset period PR2 includes a fourth period P14, a fifth period P15, and a sixth period P16. In the fourth period P14, the Y electrode lines Yi of the first group G11 and the second group G12 maintain the first level of Vsch,

In the fifth period P15, when the first scan switching device SC1 corresponding to the second group G12 is on and the second switching device SC22 corresponding to the second group G12 is off, the first scan switching device SC1 corresponding to the first group G11 is off, and the second scan switching device SC2 corresponding to the first group G11 is on. In the sixth period P16, the first scan switching device SC1 corresponding to the first group G11 is off and the second switching device SC2 corresponding to the first group G11 is on, the first scan switching device SC21 corresponding to the second group G12 is off, and the second scan switching device SC22 corresponding to the second group G12 is on.

In the embodiment illustrated in FIG. 5, the Y electrode lines are divided into the first group G11 and the second group G12 from one end of the PDP to the other. When the number of the Y electrode lines is even, the first group G11 and the second group G12 may have the same number of Y electrode lines. A difference in the numbers of Y electrode lines included in the first group G11 and the second group G12 may be very small.

The time when the first control switch SC21 is off and the second control switch SC22 is on in the Y electrode lines of the second group G12 is different from the time when the first control switch SC1 is off and the second control switch SC2 is on in the Y electrode lines of the first group G11.

Referring to FIG. 6, a switching control time of the second group G12 is controlled so as to come after a switching control time of the first group G11. Therefore, since a current of all the Y electrode lines does not change at the same time, the maximum change in current at any single time is reduced, thereby reducing the amount of EMI.

In the address period PA, a scan pulse is sequentially applied to the Y electrodes Y₁ through to Yₙ, and a display data signal is applied to A electrodes A₁ through to Aₘ in coordination with the scan pulse so as to perform an address discharge, so that the discharge cells for performing a sustain discharge in the sustain-discharge period PS can be selected.

In the address period PA, when all of the Y electrode lines are biased to a high scan voltage Vsch+Vscl, a scan pulse having a low scan voltage Vscl that is lower than the high scan voltage Vsch+Vscl is sequentially applied to the Y electrode lines. Also, a data pulse that has a positive address voltage Va and is synchronized with the scan pulse is applied to the display data signal.

The Y electrode lines are biased to the high scan voltage Vsch+Vscl when the first scan switching devices SC1 and SC21 are off and the second scan switching devices SC2 and SC22 are on. The scan pulse can be generated when the first scan switching devices SC1 and SC21 are on and the second scan switching devices SC2 and SC22 are off.

In the sustain-discharge period PS, a sustain pulse is alternately applied to the X electrode lines and the Y electrode lines so that a sustain discharge is performed to a present brightness according to the gray scale weight assigned to each sub-field. The sustain pulse alternately has a sustain discharge voltage Vs and a ground voltage Vg.

Each of the drivers illustrated in FIG. 2 output driving signals as illustrated in FIG. 6 but drivers configured to output other signals may additionally or alternatively be used.

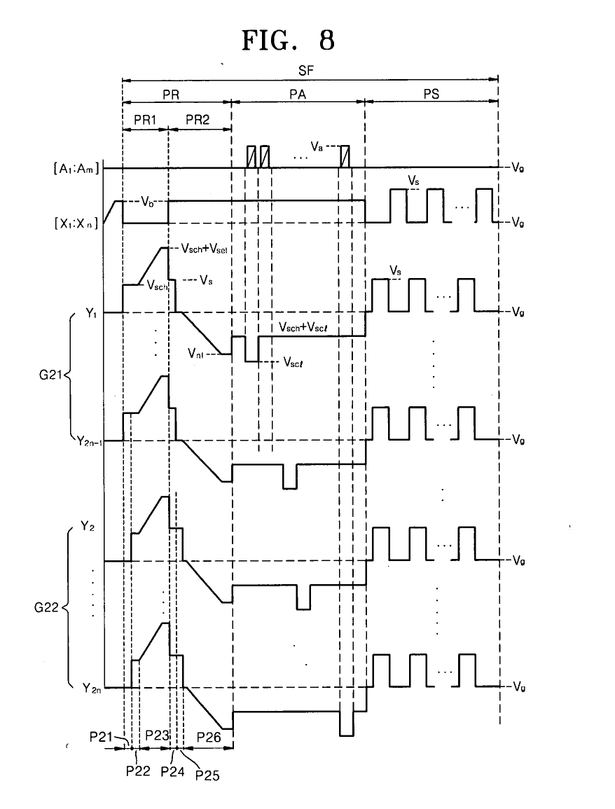

FIG. 7 is a diagram schematically illustrating the Y electrode lines Yi of the PDP I illustrated in FIG. 1, in which even electrode lines and odd electrode lines are divided into two groups. FIG. 8 is a timing diagram of driving signals output from the drivers illustrated in FIG. 2 for the PDP illustrated in FIG. 7.

Referring to FIGS. 7 and 8, a method of driving the PDP comprises applying voltages of one or more levels to each of a plurality of electrode lines. The Y electrode lines are divided into two groups (G21 and G22) and times when the first scan switching device SC1 is off and the second scan switching device SC2 is on are different according to the groups.

The embodiment of FIG. 7 is different from the embodiment illustrated in FIGS. 5 and 6 in terms of the method of dividing the Y electrode lines into two groups.

A unit frame of the plasma display panel is divided into a plurality of subfields, wherein each subfield has a gray scale weight for driving a time division gray scale display, and each subfield SF includes a reset period PR, an address period PA, and a sustain-discharge period PS. The reset period PR includes a first reset period PR1 and a second reset period PR2.

The first reset period PR1 includes a first period P21, a second period P22, and a third period P23. In the first period P21, when the first control switch corresponding to the second group G22, i.e., the first scan switching device SC21, is off, and the second control switch corresponding to the second group G22, i.e., the second scan switching device SC22, is on, the first scan switching device SC1 corresponding to the first group G21 is on and the second switching device SC2 corresponding to the first group G21 is off.

In the second period P22, when the first scan switching device SC1 corresponding to the first group G21 is on and the second switching device SC2 corresponding to the first group G21 is off, the first scan switching device SC21 corresponding to the second group G22 is on, and the second scan switching device SC22 corresponding to the second group G22 is off. In the third period P23, a rising ramp pulse waveform voltage that rises from a first level of Vsch to a third level of Vsch+Vset is applied to the Y electrode lines Yi.

The second reset period PR2 includes a fourth period P24, a fifth period P25, and a sixth period P26. In the fourth period P24, the Y electrode lines Yi of the first group G21 and the second group G22 maintain the first level of Vsch,

In the fifth period P25, when the first scan switching device SC1 corresponding to the second group G22 is on and the second switching device SC22 corresponding to the second group G22 is off, the first scan switching device SC1 corresponding to the first group G21 is off, and the second scan switching device SC2 corresponding to the first group G21 is on. In the sixth period P26, the first scan switching device SC I corresponding to the first group G21 is off and the second switching device SC2 corresponding to the first group G21 is on, the first scan switching device SC21 corresponding to the second group G22 is off, and the second scan switching device SC22 corresponding to the second group G22 is on.

In the present embodiment illustrated in FIG. 7, the odd Y electrode lines are included in the first group G21 and the even Y electrode lines are included in the second group G22 divided sequentially from one end of the plasma display panel to the other. When the number of Y electrode lines is even, the first group G21 and the second group G22 may have the same number of Y electrode lines. A difference in the numbers of Y electrode lines included in the first group G21 and the second group G22 may be very small.

Referring to FIG. 8, the switching control timing of the second group G22 is controlled so as to come after switching control timing of the first group G21. Therefore, since the current of all the Y electrode lines does not change at the same time, the maximum change in current at a single time is reduced, thereby reducing the EMI.

In the address period PA, when all the Y electrode lines are biased to a high scan voltage Vsch+Vscl, a scan pulse having a low scan voltage Vscl that is lower than the high scan voltage Vsch+Vscl is sequentially applied to the odd Y electrode lines, and then a scan pulse having the low scan voltage Vscl that is lower than the high scan voltage Vsch+Vscl is sequentially applied to the even Y electrode lines. At this time, a data pulse that has a positive address voltage Va and is synchronized with the scan pulse is applied to the display data signal.

According to the method and apparatus for driving a display panel, electrode lines to which the same signal is applied are divided into two or more groups and times when signals are applied are different according to the groups, thereby reducing the EMI caused by an abrupt change in current.

While the embodiments discussed have particularly shown and described certain inventive features, it will be understood by those of ordinary skill in the art that various changes in form and details may be made therein without departing from the spirit and scope of the present invention.

What is claimed is:

1. An apparatus configured to drive a display panel by applying voltages of one or more levels to each of a plurality of electrode lines, wherein the plurality of electrode lines are divided into a plurality of groups of electrode lines, the apparatus comprising:
at least two first control switches, each of the first control switches configured to control a connection between a power source of a first level and one of the groups of electrode lines, wherein the first control switches are configured to switch the power source of the first level to each of the electrode lines at a time determined based at least in part on the group the electrode lines are associated with; and
at least two second control switches, each of the second control switches configured to control a connection between a power source of a second level and one of the groups of electrode lines, wherein the second control switches are configured to switch the power source of the second level to each of the electrode lines at a time determined based at least in part on the group the electrode lines are associated with.

2. The apparatus of claim 1, wherein the first control switches are configured to conduct and the second control switches are configured to electrically isolate at times determined based at least in part on the group to which the first and second control switches are connected.

3. The apparatus of claim 1, wherein the first control switches are configured to electrically isolate and the second control switches are configured to conduct at times determined based at least in part on the group to which the first and second control switches are connected.

4. The apparatus of claim 1, wherein the electrode lines are divided into a first group and a second group, and a time when the first control switches are on and the second control switches are off, or a time when the first control switches are off and the second control switches are on for the electrode lines of the second group comes after a time when the first control switches are on and the second control switches are off, or a time when the first control switches are off and the second control switches are on for the electrode lines of the first group.

5. The apparatus of claim 4, wherein the electrode lines extend in a direction of the display panel, and the first group includes the odd electrode lines and the second group includes the even electrode lines.

6. The apparatus of claim 4, wherein the electrode lines extend in a direction of the display panel, and are divided such that the first group is substantially on one side of a center line of the display panel and the second group is substantially on the other side of the center line of the display panel.

7. The apparatus of claim 1, wherein a first group and a second group include the same number of electrode lines.

8. The apparatus of claim 1, wherein the first level is higher than the second level.

9. The apparatus of claim 1, wherein the plurality of electrode lines includes one or more of X electrode lines, Y electrode lines, and address electrode lines, wherein discharge cells are formed near where X electrode lines and Y electrode lines extend so as to cross address electrode lines.

10. An apparatus configured to drive a display panel comprising discharge cells formed near where X electrode lines and Y electrode lines extend so as to cross address electrode lines, wherein the Y electrode lines are divided into a plurality of groups of Y electrode lines, the apparatus comprising:
at least two first control switches, each of the first control switches configured to control a connection between a power source of a first level and one of the groups of Y electrode lines, wherein the first control switches are configured to switch the power source of the first level to each of the Y electrode lines at a time determined based at least in part on the group the Y electrode lines are associated with; and
at least two second control switches, each of the second control switches configured to control a connection between a power source of a second level and one of the groups of Y electrode lines, wherein the second control switches are configured to switch the power source of the first level to each of the Y electrode lines at a time determined based at least in part on the group the Y electrode lines are associated with,
wherein the apparatus is configured to apply voltages of one or more levels to each of the Y electrode lines.

11. The apparatus of claim 10, wherein the first control switches are configured to conduct and the second control switches are configured to isolate or the first control switches are configured to isolate and the second control switches are configured to conduct at times determined based at least in part on the group to which the first and second switches are connected.

12. The apparatus of claim 11, wherein each frame includes a plurality of subfields, each subfield has a corresponding gray scale weight for displaying a time division gray scale, a reset period, an address period, and a sustain-discharge period, wherein during the address period a scan pulse is sequentially applied to the Y electrode lines when the first control switches are off and the second control switches are on, and a data pulse is applied to the address electrode lines of a discharge cell in order to select discharge cells that are to display.

13. The apparatus of claim 12, wherein the reset period includes a first reset period during which a rising voltage that rises from the first level to a third level is applied to the Y electrode lines, and a second reset period during which a falling voltage that falls from a fourth level to a fifth level is applied to the Y electrode lines.

14. The apparatus of claim 13, wherein the Y electrode lines are divided into a first group and a second group, and a time when the first control switches are on and the second control switches are off, or a time when the first control switches are off and the second control switches are on for the Y electrode lines of the second group comes after a time when the first control switches are on and the second control switches are off, or a time when the first control switches are off and the second control switches are on for the Y electrode lines of the first group.

15. The apparatus of claim 14, wherein the first reset period comprises:
a first period during which the first control switches corresponding to the second group are off, and the second control switches corresponding to the second group are on, the first control switches corresponding to the first group are on and the second control switches corresponding to the first group are off,
a second period during which the first control switches corresponding to the first group are on and the second control switches corresponding to the first group are off, the first control switches corresponding to the second group are on, and the second control switches corresponding to the second group are off; and
a third period during which a rising voltage that rises from the first level to the third level is applied to the Y electrode lines.

16. The apparatus of claim 14, wherein the second reset period comprises:
a fourth period during which the Y electrode lines of the first group and Y electrode lines of the second group maintain the first level;
a fifth period during which when the first control switches corresponding to the second group are on and the second control switches corresponding to the second group are off, the first control switches corresponding to the first group are off, and the second control switches corresponding to the first group are on; and
a sixth period during which when the first control switches corresponding to the first group are off and the second first control switches corresponding to the first group are on, the first control switches corresponding to the second group are off, and the second control switches corresponding to the second group are on.

17. The apparatus of claim 14, wherein the Y electrode lines extend in a direction of the display panel, and are divided such that the first group is substantially on one side of a center line of the display panel and the second group is substantially on the other side of a center line of the display panel.

18. The apparatus of claim 14, wherein the electrode lines extend in a direction of the display panel, and the first group includes the odd Y electrode lines and the second group includes the even Y electrode lines.

19. The apparatus of claim 10, wherein a first group and a second group include the same number of Y electrode lines.

20. The apparatus of claim 10, wherein the first level is higher than the second level.

21. A method of driving a display panel, the method comprising:
applying voltages of one or more levels to each of a plurality of electrode lines with an apparatus configured to drive the display panel, wherein the electrode lines are divided into a plurality of groups of electrode lines, the apparatus comprising:
at least two first control switches, each of the first control switches configured to control a connection between a power source of a first level and one of the groups of electrode lines, wherein the first control switches are configured to switch the power source of the first level to each of the electrode lines at a time determined based at least in part on the group the electrode lines are associated with; and
at least two second control switches, each of the second control switches configured to control a connection between a power source of a second level and one of the groups of electrode lines, wherein the second control switches are configured to switch the power source of the second level to each of the electrode lines at a time determined based at least in part on the group the electrode lines are associated with.

22. The method of claim 21, wherein the electrode lines are divided into a first group and a second group, and a time when the first control switches are on and the second control switches are off, or a time when the first control switches are off and the second control switches are on for the electrode lines of the second group comes after a time when the first control switches are on and the second control switches are off, or the time when the first control switches are off and the second control switches are on for the electrode lines of the first group.

23. The method of claim 22, wherein the plurality of electrode lines includes one or more of X electrode lines, Y electrode lines, and address electrode lines, wherein discharge cells are formed near where X electrode lines and Y electrode lines extend so as to cross address electrode lines.

24. The method of claim 23, wherein each frame includes a plurality of subfields, each subfield has a corresponding gray scale weight for displaying a time division gray scale, a reset period, an address period, and a sustain-discharge period, wherein during the address period, a scan pulse is sequentially applied to the Y electrode lines when the first control switches are off and the second control switches are on, and a data pulse is applied to the address electrode lines of a discharge cell in order to select discharge cells that are to display.

25. The method of claim 24, wherein the reset period comprises:
a first reset period during which when the first control switches corresponding to the second group are off, and the second control switches corresponding to the second group are on, the first control switches corresponding to the first group are on and the second control switches corresponding to the first group are off, and
a second reset period during which when the first control switches corresponding to the first group are on and the second control switches corresponding to the first group are off, the first control switches corresponding to the second group are on, and the second control switches corresponding to the second group are off, and
a third period during which a voltage that rises from the first level to the third level is applied to the Y electrode lines.

26. The method of claim 25, wherein the second reset period comprises:
a fourth period during which the Y electrode lines of the first group and the Y electrode lines of the second group maintain the first level;
a fifth period during which when the first control switches corresponding to the second group are on and the second control switches corresponding to the second group are off, the first control switches corresponding to the first group are off, and the second control switches corresponding to the first group are on; and
a sixth period during which when the first control switches corresponding to the first group are off and the second first control switches corresponding to the first group are on, the first control switches corresponding to the second group are off, and the second control switches corresponding to the second group are on.

27. The method of claim 22, wherein the Y electrode lines extend in a direction of the display panel, and are divided such that the first group is substantially on one side of a center line of the display panel and the second group is substantially on the other side of the center line of the display panel.

28. The method of claim 22, wherein the electrode lines extend in a direction of the display panel, and the first group includes the odd Y electrode lines and the second group includes the even Y electrode lines.
